(19) United States
(12) Patent Application Publication
(10) Pub. No.: US 2015/0246361 A1
(43) Pub. Date: Sep. 3, 2015

(54) METHOD AND DEVICE FOR SEPARATING FINE-GRAINED FRACTIONS FROM THE CINDERS OF A WASTE INCINERATION PLANT

(71) Applicant: DOIKOS INVESTMENTS LTD., Jersey Channel Islands (GB)

(72) Inventors: Rainer Bunge, Alpthal (CH); Martin Stiefel, Ottikon (CH)

(73) Assignee: DOIKOS INVESTMENTS LTD., Jersey Channel Islands (US)

(21) Appl. No.: 14/424,732

(22) PCT Filed: Aug. 27, 2013
(86) PCT No.: PCT/EP2013/067725

§ 371 Date: Feb. 27, 2015

(30) Foreign Application Priority Data
Aug. 28, 2012 (CH) 1497/12

(51) Int. Cl. B03C 3/017; B01D 46/00; B01D 50/00; B01D 45/16

(52) U.S. Cl. CPC B03C 3/017; B01D 45/16; B01D 46/0032; B01D 50/002

(57) ABSTRACT

The method is characterized in that the fine-grained fractions are extracted by means of a gas flow at least at one point in the cinder shaft (4) using a fan blower (8) and a connected pipe (9). The extracted gas is conducted through separators (10, 11) and the fine-grained fractions are separated therein from the gas by means of chemical, mechanical or electrical treatment. The gas which has been freed of the fine-grained fractions is thereafter blown in the same volume back into the cinder shaft (4), such that the gas flow balance and the pressure conditions therein remain unchanged in the upper and lower regions. The device for this purpose consists of at least one pipe connection in the cinder shaft wall to an extraction pipe (9), the outgoing extraction pipe (9) being connected to a fan blower (8) and to at least one separating device, (10, 11) for extracting the fine-grained fractions from the gas. A return pipe (13) is used for feeding the gas freed of the fine-grained fractions back into the cinder shaft (4).

The invention relates to a method and a device for the separation of fine-grained fractions from the cinder (=bottom ash) of a waste incineration plant, on the one hand, to improve the quality of cinder with a view to re-use in the construction industry, and on the other hand, to recover valuable fractions from the cinder.

In modern waste incineration plants, the waste is burnt on step grates, and at the end of the combustion, ash and burnt-out cinder only remain. At the end of the combustion grate, these ashes and cinders are thrown into one or more ash hoppers through a knife edge. The ash hopper leads into a cinder shaft, which, in turn, leads into a wet ash extractor or a dry ash extractor. In the case of a wet ash extractor, this is a U-shaped syphon filled with water, of which one leg drops down the cinder from the combustion grate into the water bath. Then, this cinder is carried away from the water bath through the other leg by means of a mechanical discharge device. The water bath prevents the false air from being drawn into the furnace under vacuum through the ash extractor, which would lead to problems with proper firing schedule. In case of a dry discharge, it is attempted to avoid the entry of false air as much as possible, but it will never be entirely satisfactory.

The problem is that the quality of the cinder deteriorates considerably in terms of water-soluble heavy metals due to the contact with water, which is also the case here, if dry discharged cinder is sprinkled with water after depositing. The fine-grained fraction of this cinder generally contains fractions of readily water-soluble heavy metal salts in the water. These dissolved heavy metals are transferred to the coarser cinder particles in the water bath by two mechanisms: On the one hand, the dissolved heavy metals with the material moisture adhering to coarse-grained fractions enter the discharged cinder. On the other hand, an adsorption of heavy metals, in particular on to iron oxide surfaces, also plays a role. Therefore, through contact with the water bath, an unintended transfer of the heavy metals available in the form of readily water-soluble compounds is made from the fine-grained fractions to the coarse-grained fractions. This leads to the fact that the cinder discharged from the wet ash extractor, just like the dry discharged cinder, has significant amount of water-soluble heavy metals, and therefore can be used only to a very limited extent for the recycling as a building material In addition, it is disadvantageous that the scrap iron is contaminated with heavy metals through the above-mentioned adsorption mechanism and, is therefore of poor chemical quality.

The ashes and cinders contain various recyclable materials such as ferrous and non-ferrous metals. In particular, the fine fraction of, say, <1-2 mm contains a high proportion of such materials. A second disadvantage of the water bath of the cinder is that, firstly, these materials are subjected to corrosion due to chemical processes, and secondly, they are lost with the cinder. This is particularly so, because the mineral ingredients adhere to the cinder after humidification and the metal particles are included in a cement-like cinder matrix. Because the prices of certain metals have risen substantially over the last few years, it may be increasingly desired in the relevant industry to recycle these metals efficiently. The recovery of metals from the cinder or specifically this fine fraction, may be used, but proves to be particularly difficult after wetting in a water bath.

For the solution of these problems, there are basically two approaches to date. On the one hand it was attempted to wash the cinder directly in the ash extractor or shortly thereafter, and to flush out the readily soluble heavy metals. This requires a sophisticated on-site waste water treatment, which is usually not practicable in the premises of waste incineration plants. In addition, the outcome of purification in the case of adsorbed heavy metals is unsatisfactory. The second approach to the solution aims to discharge the cinder not through a water bath but in a dry state. The fine-grained fractions enriched with readily water-soluble heavy metals are then separated from the coarser-grained fractions, e.g. by sifting or sieving, after the discharge from the furnace. The thus dust-removed coarse-grained fractions show a significantly lower content of water-soluble heavy metals than that of the originally discharged cinder in total. But, in the case of dry discharge, apart from the formation of dust, the problem is the air-tight sealing of the combustion furnace. The false air flow through the dry ash extractor must therefore be minimised by various arrangements in order not to adversely affect a proper firing schedule in the furnace. As unintended positive side effect, the entering false air drags extremely fine-grained fractions of the cinder into the interior of the furnace and transfers them into the filter ash, which is separated by the mechanical flue gas purification.

The object of the present invention is therefore to find out a procedure and a device, which bring out the cinder in a form in which the metals can be extracted from it, and thus the mineral fraction can be exploited as a building material, but without having to deal with the problems mentioned above with the cinder wash and the false air entry during dry discharge.

This task is solved by a method for the separation of fine-grained fractions from the cinder of a waste incineration plant, on the one hand, to improve the quality of cinder with a view to re-use in the construction industry, and on the other hand, to recover valuable fractions of it, where the procedure is characterised in that a separately induced gas flow from exhaust gas or fresh air by which the cinder that is either available in the annealing zone of the grate or found to fall under gravity in the cinder shaft, is conducted, so that the fine-grained fractions found in the cinder are carried along by this gas flow and conducted by it through one or more separators, and that the fine-grained fractions are separated from the gas flow by means of chemical, mechanical or electrical treatment, and that this gas flow that is separately induced and freed from the fine-grained fractions is blown into the cinder shaft or in the annealing zone of the combustion grate,

The object is further accomplished by a device for the separation of the fine-grained fractions from the cinder of a waste incineration plant, on the one hand, to improve the quality of cinder with a view to re-use in the construction industry, and on the other hand, to recover valuable fractions, consisting of at least one pipe fitting in the cinder shaft wall with a suction pipe, where this conducting suction pipe is connected to at least one separator for the extraction of dust particles from the gas, as well as to at least one return pipe for recirculation of the gas freed from the dust particles into the cinder shaft, which is conducted through a fan blower, where the suction and the exhaust pipes are so positioned that the induced exhaust gas flow is forced through the cinder.

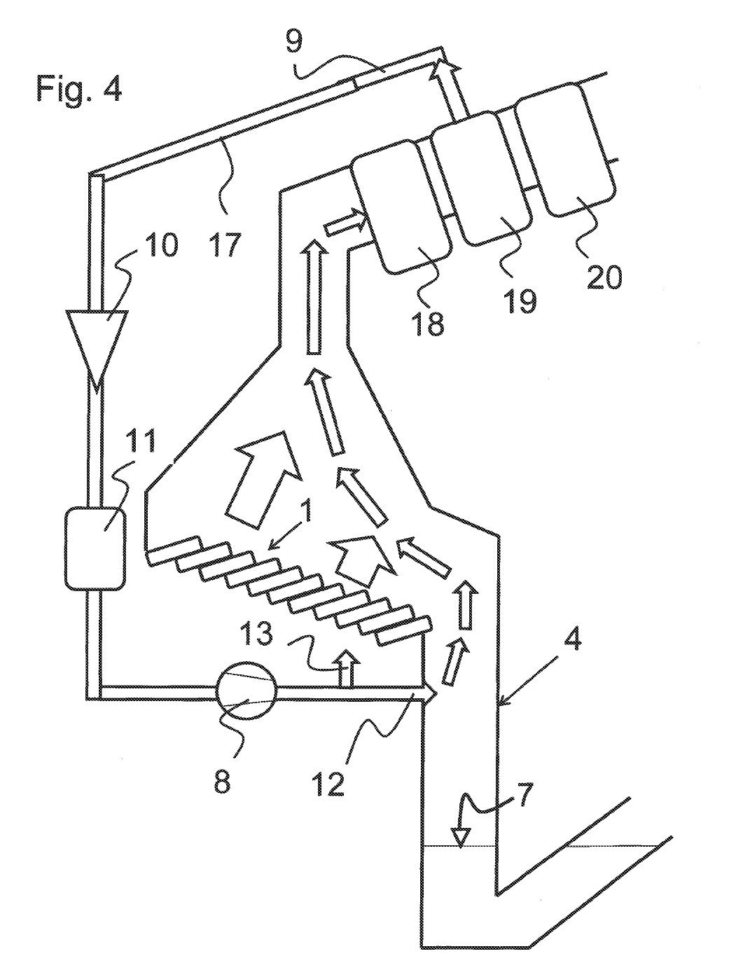

WO02/086388 discloses a device that works with a separately induced gas flow in the cinder drop shaft, which at first glance seems to reveal the same arrangement. But the gas flow is used only to keep the cinder outflow (FIG. 4, 206) hot. This is done by using a barrier gas circulation to prevent a rise of the cold gas from the water bath placed at the bottom (page 10 lines 16-30). As described on page 11 line 25 of WO02/086388, the dust collector (214) is used only for protecting the fan (215). So it will be tried to mount the suction port (211) in such a way that as little dust as possible will be dragged along by the extracted gas. Accordingly, in the device according to WO02/086388 the circulating gas flow is directed in parallel with the cinder flow from top to bottom, where a through flow of the cinder is avoided as much as possible by means of the rotating gas flow, by sucking the air at a certain wall (211) and also specifically blowing back at the same wall of the device (212). Thus, in FIG. 4 of WO02/086388, where a sketch of the device has been given, it is neither intended to remove dust from the falling ash, nor it is suitable to do so at all. Because as little dust as possible would be swept away, this document does not contain the underlying idea of the present invention. The main idea of this invention is that the gas flow is conducted through the cinder to take out the fine-grained fractions found in it. This removal is advantageous, but not necessarily by means of a transverse or counterflow component in the general down-draft of the cinder.

In the figures, embodiments of the device presented here have been shown. The procedure is described using these figures, and its function is explained.

In the drawings:

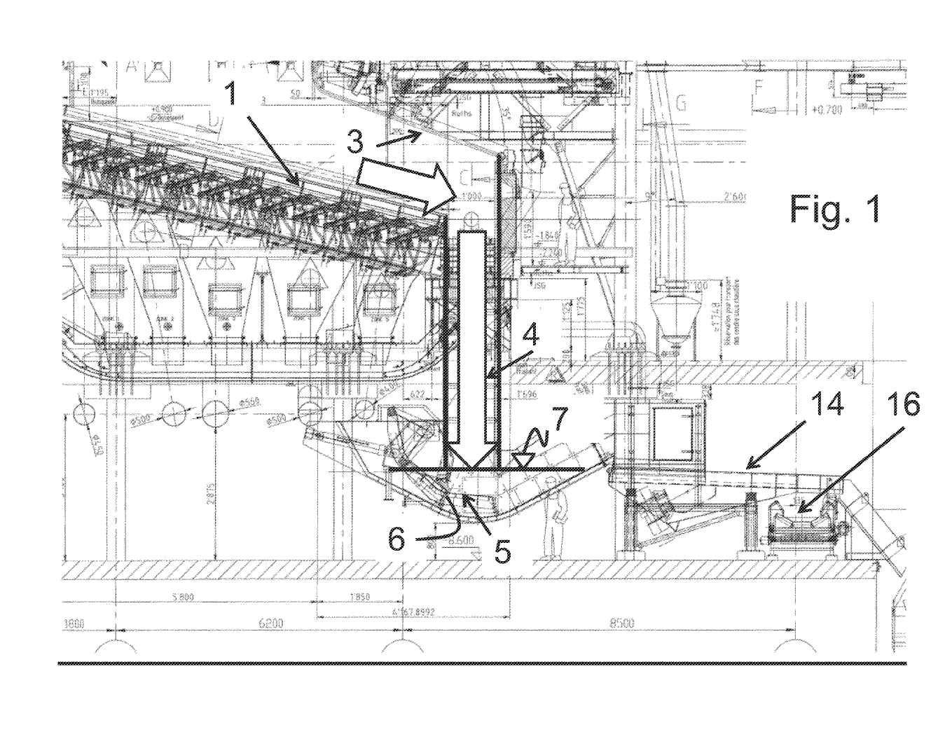

FIG. 1: A longitudinal section through a combustion grate with a connected cinder drop shaft, cinder trap and ejector as well as cinder conveyor for a wet discharge of the cinder;

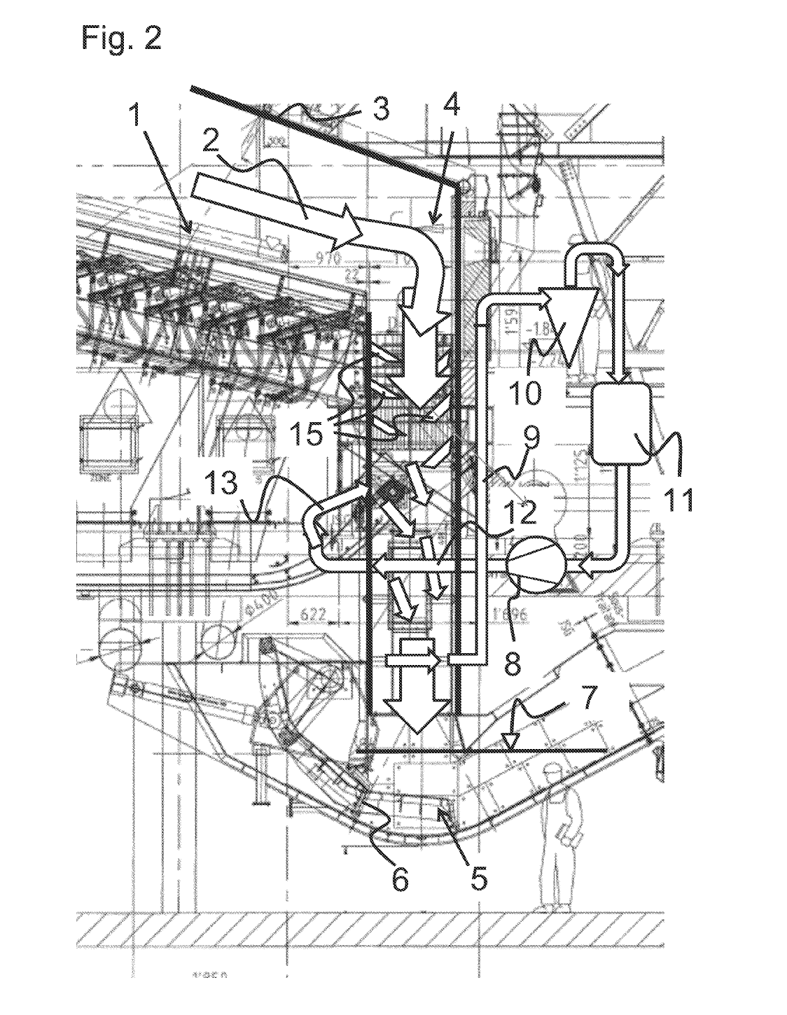

FIG. 2: A sectional view of the longitudinal section of FIG. 1, namely the end zone of the combustion grate, as well as the cinder drop shaft with cinder trap, but with an installed dust particle separating device around the cinder drop shaft ;

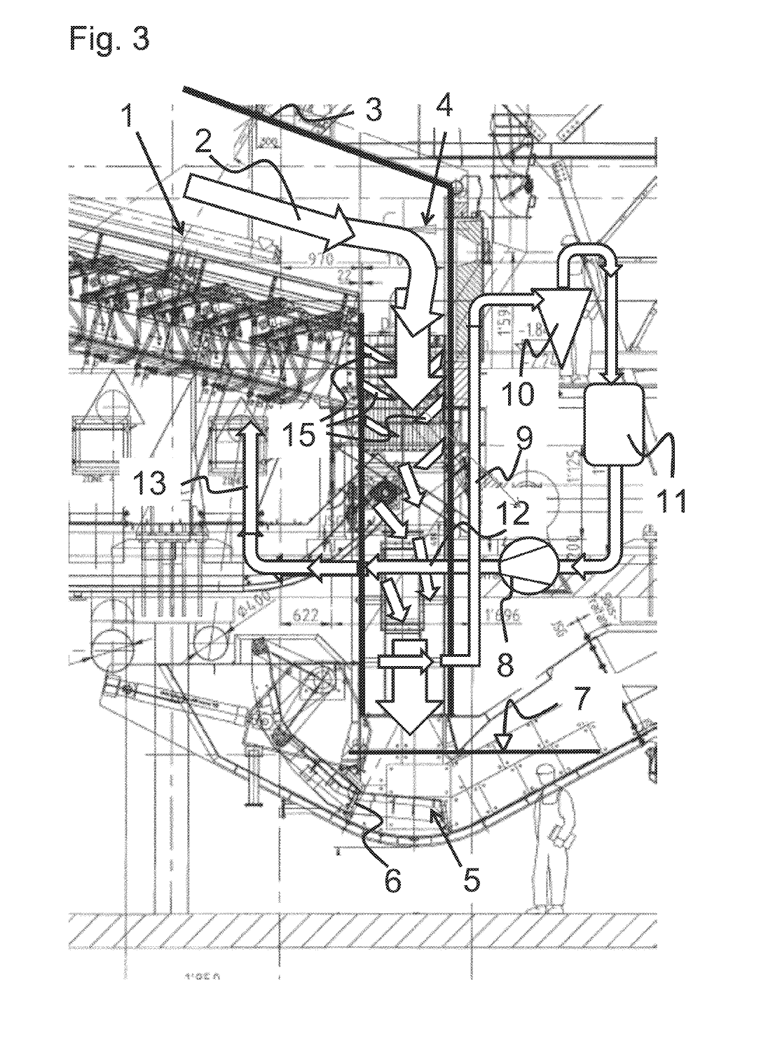

FIG. 3: A diagrammatic representation of a plant in which the gas flow is injected across the cinder trough, and afterwards the fine-grained particles of the grate cinder are extracted with the flue gas upwards, where the same gas flow is diverted in the mechanical flue gas purification and fed back under the grate or into the cinder trough after separation of the fine-grained particles.

FIG. 4: A longitudinal section through a combustion grate with connected cinder drop shaft, with an induced counter-exhaust gas flow, with fine grain separation with the flue gas and feeding under the annealing zone of the grate and into the cinder shaft.

According to the process according to the invention, the fine-grained fractions of the cinder are removed before the entry into the ash extractor by a flow bifurcation (“sifting”), and the cinder is extracted conventionally by a wet or dry ash extractor. The zone directly in front of the cinder knife edge of the combustion grate is also designated as annealing zone. There, the losses of ignition of the materials found on it are limited to less than 15%, and 85% or more bare cinder is found in this grate region. The dust removal takes place either in this annealing zone, in which essentially the cinder horizontally migrating on the grate is flown through from the bottom by the exhaust gas, or in the discharge chute, which connects the grate with the ash extractor, and through which shaft a gas flow is passed. A characteristic feature of the procedure is the use of a specifically induced as flow for dust removal. This gas flow can consist of pure exhaust gas, or even be enriched with fresh air. It is induced with sufficient strength in the cinder shaft or combustion chamber using blowers. With a flow velocity of approx. 0.1 m/s for the cinder, which has a density of 2.5 g/cm³ a split cut of about 0.03 mm grain size has been achieved, and with a flow velocity of 10 m/s a split cut of around 1 mm grain size has been achieved. The use of exhaust gas is in sharp contrast to the dust removal described above using the “false air” entering through a dry ash extractor, said false air is not exhaust gas but ambient air, and which affects the firing schedule in the furnace because of its high oxygen content. Exhaust gas is understood here to be a gas, which contains less than 10% oxygen, preferably between 6% to 10%, in order not to disturb the combustion processes to the maximum possible extent. This device according to the invention for the exhaust gas used for dust removal is sucked from the upper regions of the cinder shaft or from the plants meant for energy production, and mechanical flue gas purification as well as chemical flue gas purification using one or more blowers, and is fed back into the cinder discharge chute or under the part of the combustion grate found just before the cinder knife edge, so that a balanced inlet and outlet flow of the additional gas is achieved for the dust removal and the stoichiometry of the firing schedule remains unaffected. The fine-grained fractions of the cinder dragged along by the circulating gas flow are separated by the mechanical flue gas purification, i.e., the filter, together with the filter ash. But they can also be separately removed.

As we can see from FIG. 1, which shows a sectional view through a type of conventional waste incineration plant, the waste comes here from the left on to the combustion grate 1 and is then completely burnt in different zones, and is conveyed by the scraping and transport movements of the individual grate plates of the combustion grate 1 from left to right as shown in the figure. Above the end zone of the combustion grate 1, the boiler wall 3 can be seen, which, in turn, goes vertically upwards over the combustion grate 1 and forms a part of the flue gas duct of the plant. At the end of the combustion grate 1, the cinder, which is the residue of the burned-out waste, falls into the cinder shaft 4 as indicated by the arrow. In this cinder shaft 4, the cinder falls due to gravity along the vertical arrow down into the cinder trap 5, which is filled with water up to the horizontal line 7 indicated. This avoids a dust generation during the subsequent transport of the cinder and cools it. The cinder ejector 6 ejects the cinder periodically, as shown in the figure, from left to right from the cinder trap 5 on to a vibrating trough, which evens out the cinder, so that finally the wet cinder falls on a conveyor belt 16, which further conveys it to a transport container or bunker. The cinder shaft 4 measures here a few meters in width, that is to say, it is as wide as the combustion grate 1, and its depth is 5 m to 6 m and its lateral dimension is lm here. These dimensions will be adapted to the relevant plant, and can obviously vary of course. Further, FIG. 1 shows a conventional plant.

The system for separation of the fine-grained fractions in the cinder is now based on a specifically induced gas flow guided along the cinder or ash path. Just above or in the zone of the induced gas flow, which preferably consists of exhaust gas, additional active or passive components are provided for breaking up, loosening or better distribution of the cinder. The gas flow then conveys the finer ingredients from the cinder path into a separate path. This particle-laden air is guided over cyclones, electrostatic filters and dust filters, in order to separate the solid components, in particular fine-grained mineral fractions, heavy metals, ferrous or non-ferrous metals and heavy metal salts from the gas flow. The gas flow is then sucked in by a blower and is blown back into the cinder path or into the lower wind zone of the combustion grate 1, and there, in particular, under the cinder annealing zone in front of the knife edge 2. Because a lot of gas is blown into this area associated with the fire chamber or directly under the combustion grate 1 and simultaneously extracted, the combustion process, the flue gas amounts, emissions and temperatures of this system are not influenced. If an air exchange is specifically required in this system, additional air can be fed using an additional blower or a false air valve at the suction side. Thus, in this special case the flow balance between the beginning and the end of the cinder trough accordingly involves exceptional changes. In order to be able to influence the carrying along of the fine-grained particles, the gas flow is regulated, such as by a frequency control of the blower or through appropriate fittings. In addition, the injection can be done by using variable nozzles and changing the injection angle and the penetration depth.

A typical arrangement for the suction circuit is typically installed around the cinder shaft 4. In the cinder shaft, the nozzles are arranged on the one side for the return feed, and on the opposite side of the connection for the suction. The nozzles are slightly tilted upwards, so that the falling particles are decelerated, and blown to the opposite side of the cinder shaft 4. The sucked gas flow is directed through a cyclone and then an electrostatic filter, More filter variants of different type can also be installed, including the hose filters. For example, the separated solid substances are conveyed from the filter through cellular wheel sluices and collected. The purified gas flow is blown back through one or more fan blowers into the shaft or into the lower wind zone of the combustion grate 1. Such an arrangement could also be installed directly at the end of the grate.

FIG. 2 shows a plant with the device according to the invention for dust separation. A sectional view of the longitudinal section of FIG. 1 is shown, namely the end zone of the combustion grate 1, as well as the cinder drop shaft 4 with cinder trap 5, but with an installed dust particle separating device installed around the cinder drop shaft 4. This is formed from at least one piping circuit. Here, in the figure on the right side of the cinder shaft 4, there is a pipe 9 running to the outside from the inside of the lower section of the cinder shaft 4, where the dust content is maximum. Here, it runs upwards outside at the wall of the cinder shaft 4 and then sidewards into a cyclone 10 and then out of it upwards from its inside lower tip and then downwards into an electrostatic filter 11. After this, the suction circuit runs through a fan blower 8. By means of this fan blower 8, a vacuum can be produced at the inlet of the pipe 9, so that the surrounding gas loaded with dust particles is sucked and forced through one or more separating devices 10, 11. Above the suction zone, baffle plates 15 are installed in the cinder shaft 4, which are tilted down. During the operation of the fan blower 8, the airflow in the cinder shaft 4 is deflected, as shown by the arrows, and, sucked to the maximum extent, as shown by the horizontal arrow. The power of the fan blower 8 can be regulated by means of a frequency controller, or the gas flow in the suction pipe can be throttled using valves. Some gas particles can thus easily pass through the suction circuit several times.

A first separating device 11 is shown here in the form of a cyclone 10. Because of only a moderate filter performance in comparison to other procedures in the case of finest particles, it is often used as part of a series of filters, in order to separate the heavy particles.

Using a downstream electrostatic filter 11, in accordance with the usual manner as adopted for the purification of exhaust gases, more particles, such as the ultra-fine particles, are separated. These filter residues (fly ash) are treated afterwards through further processes, in order to separate the valuable ingredients from the rest. Almost 100% of the dust mass found in the gas can be removed by electrostatic filter. The electrostatic filter does not have the same separation rate for all grain sizes of the dust. In particular, dusts with a small grain size (fine particles), in which preferably heavy metals and other contaminants accumulate, are filtered off only to the extent of approximately 95%. According to the invention, the unloaded gas is conducted via the return line 12 through a fan blower 8 with frequency control, and then fed back into the cinder trough 4 through the feed pipe 13 with a slightly upwards tilted nozzle. But, the recirculation can also be done directly into the area under the combustion grate 1, preferably into the annealing zone, as shown in FIG. 3, The recirculated air is blown in with a correspondingly high momentum into the cinder shaft, in order to separate the fine fraction as efficiently as possible from the remaining cinder. If the air intake of the pipe 9 or alternatively an additional air intake is arranged in the gas injectors, then the gas loaded with dust is blown directly to this suction port.

Thus the operation of this particle separation from the dust in the cinder trough 4 is pressure-neutral and air quantity-neutral. Exactly as much exhaust gas that is extracted is fed per unit time into the cinder trough 4. Consequently, there are no changes to the pressure above and below the suction and feed. It is clear that several suction and feed pipes, as well as several types of filters can he combined. This can be arranged parallel to each other, or can also be arranged in series as shown here.

FIG. 4 shows an alternative, in which the gas flow is partly blown under the end edge of combustion grate 1 into the cinder shaft 4, i.e. under its annealing zone, and partly directly into the cinder shaft 4. Because of the lower pressure acting above the grate 1, the gas flows into the uptake flue as shown with the arrows, and carries with it the fine fraction contained in the cinder. The uptake flue starts with the installations for energy production 18, i.e. for the heat extraction from the flue gas, then for the mechanical flue gas purification 19 and for the chemical flue gas purification 20. In the mechanical flue gas purification 19, the fine particles are still able to slip through and are then returned with the same volume of gas sucked as that fed back in the cinder shaft through the suction line 9, and then through the return line 17 after passing through the fine particle-separating devices, namely here the cyclone 10 and afterwards the electrostatic filter 11, into the inside of the cinder trough 4 through the feed pipe 12 or into the lower wind zone of the combustion grate 1 through the feed pipe 13.

It is advantageous to arrange the fan blower 8 behind the filtering devices 10, 11 as shown, so that it is not loaded with the particles carried along by the gas, which may otherwise prove abrasive. It is also advantageous to separate the heavy particles with a cyclone 10, and then to send the gas through an electrostatic filter 11 for the separation of ultra-fine particles. More suction circuits can also be installed, which are designed for different dust particle qualities. The separated particles, which partly contain valuable substances, can then be further processed with conventional methods to separate the valuable substances from them and to deliver for recycling. The cinder further freed from the water-soluble heavy metal salts enriching the fine-grained fractions by the procedure is very well suitable for recycling in the construction industry due to its good quality, in particular, for road construction. A further advantage of separation of this fine fraction lies in the dust-free transport of the ash and cinder extracted from this fine fraction. In particular, in the case of a dry discharge system—the dry de-slagging is becoming an increasingly important topic in the industry—the untreated cinder tends to release a high amount of dust. In this case, the prior separation of the fine fraction mentioned here has the specific advantage that the normally extracted cinder now is significantly less dusty without the fine fraction that has already been separated.

1. A method for the separation of fine-grained fractions from the cinder of a waste incineration plant, by which a separately induced gas flow from either exhaust gas, sucked from any location from the exhaust gas channel, and/or fresh air, sucked from outside of the exhaust gas channel, such gas flow is conducted through the cinder that is either available in the annealing zone of the grate or found to fall under gravity, so that the fine-grained fractions found in the cinder are carried along by this gas flow and conducted by it through one or more separators (10, 11), and that the fine-grained fractions are separated from the gas flow by means of chemical, mechanical or electrical treatment, and that this gas flow that is separately induced and freed from the fine-grained fractions is blown into the cinder shaft (4) or in the annealing zone of the combustion grate (1).

2. A method according to claim 1, characterized in that the gas flow is a pure exhaust gas flow.

3. A method according to claim 1, characterized in that the gas flow is a mixture of exhaust gases and fresh air.

4. A method according to claim 1, characterized in that the exhaust gas flow contains less than 10% oxygen, preferably 6% to 10%.

5. A method according to claim 1, characterized in that the gas flow is conducted with a transverse or counterflow component through the cinder shaft.

6. A method according to claim 1, characterized in that the gas flow is sucked from a flue gas purification device (19) and blown back under the annealing zone of the combustion grate after separation of the fine-grained fraction.

7. A method according to claim 1, characterized in that the gas flow is sucked from a flue gas purification device (19) and blown into the cinder shaft (4) after separation of the fine-grained fraction.

8. A method according to claim 1, characterized in that the gas flow is induced with a velocity between 0.1 m/s and 10 m/s, using one or more blowers (8).

9. A device for the separation of fine-grained fractions from the cinder on a waste incineration plant, which has a combustion grate (1) with connected cinder shaft (4) for the cinder, and an uptake flue with flue gas purification devices (18, 19, 20), where the cinder shaft (4) can lead to a dry or wet discharge of the cinder, characterized in that the device includes a suction pipe (9)₁ a feed pipe (12, 13), a purification device and a blower, where the suction pipe (9) comes from the cinder shaft (4) or the mechanical flue gas purification device (19) and afterwards goes through separating devices (10, 11) and finally through at least one blower (8), after which through the feed pipe (12) it enters the cinder shaft (4), or under the annealing zone of the combustion grate (1).

10. A device for the separation of fine-grained fractions from the cinder on a waste incineration plant according to claim 9, characterized in that the separating devices (10, 11) include a cyclone (10) and/or an electrostatic filter (11), and an exhaust gas flow can be induced at least with a speed of 0.1 m/s in the entry zone of the feed pipe (12, 13) using the blower (8).
